(19) United States
(12) Patent Application Publication
(10) Pub. No.: US 2021/0402767 A1
(43) Pub. Date: Dec. 30, 2021

(54) Liquid Discharge Head

(71) Applicant: Brother Kogyo Kabushiki Kaisha, Nagoya-shi (JP)

(72) Inventors: Taisuke Mizuno, Yokkaichi-shi (JP); Shotaro Kanzaki, Handa-shi (JP); Keita Sugiura, Toyokawa-shi (JP)

(21) Appl. No.: 17/331,833

(22) Filed: May 27, 2021

(30) Foreign Application Priority Data
Jun. 29, 2020 (JP) 2020-111498

(51) Int. Cl. B41J 2/14

(52) U.S. Cl. CPC B41J 2/1433; B41J 2002/14338; B05B 1/14; B41J 2002/14475; B41J 2002/14467

(57) ABSTRACT

There is provided a liquid discharge head including: a nozzle member; a first common channel member including first common channels; an actuator member including pressure chambers and driving elements; a driver IC; a second common channel member including a second common channel; and a chiller configured to chill the driver IC.

### CROSS REFERENCE TO RELATED APPLICATION

The present application claims priority from Japanese Patent Application No. 2020-111498 filed on Jun. 29, 2020, the disclosure of which is incorporated herein by reference in its entirety.

### BACKGROUND

### Field of the Invention

The present disclosure relates to a liquid discharge head configured to discharge liquid from nozzles.

### Description of the Related Art

As a liquid discharge head that discharges liquid from nozzles, there is known a fluid discharge device that discharges fluid from nozzles. The publicly-known fluid discharge device includes a fluid distribution structure in which first and second interposer layers are arranged between a die formed having channels that include nozzles and a manifold formed having, for example, a fluid supply chamber and a fluid recovery chamber. The first and second interposer layers are formed having a supply channel(s) through which fluid inflows from the fluid supply chamber and then is distributed to the channels of the die and a recovery channel(s) through which fluid not discharged from the nozzles in the channels of the die circulates to or returns to the fluid recovery chamber. There is known that the die may be provided with an actuator controlled by an integrated circuit wafer and that the actuator and the integrated circuit may generate heat that is dispersed or dissipated over the whole of the die.

### SUMMARY

Assuming a case where, in the publicly-known fluid discharge device, the nozzles are arranged densely in order to downsize the device and increase operation speed and the fluid is discharged from the nozzles by driving the actuator at high driving frequency. In this case, the heat generated in the actuator and the integrated circuit may greatly increase a temperature of the fluid discharge device, which may cause a problem such as failure of the actuator and the integrated circuit.

An object of the present disclosure is to provide a liquid discharge head that allows heat generated at the time of driving to be released efficiently.

According to an aspect of the present disclosure, there is provided a liquid discharge head including: a nozzle member including a plurality of nozzle rows, each of the nozzle rows including a plurality of nozzles aligned in a first direction, the nozzle rows being arranged in a second direction intersecting with the first direction; a first common channel member disposed at one side of the nozzle member in a third direction orthogonal to the first direction and the second direction, the first common channel member including a plurality of first common channels that correspond to the respective nozzle rows, each of the first common channels extending in the first direction, the first common channels being arranged in the second direction; an actuator member disposed on a surface at the one side in the third direction of the first common channel member. The actuator member includes: a plurality of pressure chambers corresponding to the respective nozzles, each of the pressure chambers communicating with a corresponding one of the nozzles and a corresponding one of the first common channels, and a plurality of driving elements corresponding to the pressure chambers, each of the driving elements configured to apply pressure to a liquid in a corresponding one of the pressure chambers. The liquid discharge head further includes: a driver IC disposed on a surface at the one side in the third direction of the actuator member and configured to drive the driving elements; a second common channel member disposed at the one side in the third direction of the actuator member and including a second common channel that is provided in common to the first common channels, extends in the second direction, and communicates with the first common channels; and a chiller disposed at a part of the second common channel member that overlaps in the third direction with the driver IC and configured to chill the driver IC.

### BRIEF DESCRIPTION OF THE DRAWINGS

FIG. 1 depicts a schematic configuration of a printer provided with ink jet heads.

FIG. 2 is an exploded perspective view of a schematic configuration of the ink-jet head.

FIG. 3 is a plan view of a nozzle member.

FIG. 4 is a plan view of a first common channel member.

FIG. 5 is a plan view of an actuator member.

FIG. 6 is a plan view of a third common channel member.

FIG. 7 is a plan view of a second common channel member.

FIG. 8 is a cross-sectional view of the ink-jet head taken along a line VIII-VIII in FIGS. 3 to 7.

FIG. 9 is a cross-sectional view of the ink-jet head taken along a line IX-IX in FIGS. 3 to 7.

FIG. 10 is a cross-sectional view of the ink jet head taken along a line X-X in FIGS. 3 to 7.

FIG. 11 is a plan view of a second common channel member of a second embodiment.

FIG. 12 depicts an ink-jet head of the second embodiment and corresponds to FIG. 8.

FIG. 13 is a plan view of a second common channel member of a modified embodiment.

FIG. 14A is a cross-sectional view taken along a line XIVA-XIVA in FIG. 13, and FIG. 14B is a cross-sectional view taken along a line XIVB-XIVB in FIG. 13.

### DESCRIPTION OF THE EMBODIMENTS

### First Embodiment

A first embodiment of the present disclosure is explained below.

<Schematic Configuration of Printer 1>

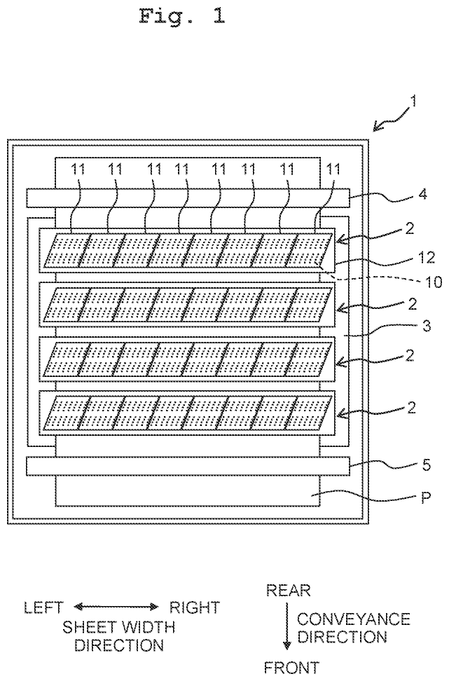

As depicted in FIG. 1, a printer 1 according to the first embodiment includes four head units 2, a platen 3, and conveyance rollers 4, 5.

Each head unit 2 includes eight ink-jet heads 11 and a head holding member 12, In each ink-jet head 11, ink is discharged from nozzles 10 formed in a lower surface of the ink-jet head 11. The eight ink-jet heads 11 are arranged in a sheet width direction (“second direction” of the present disclosure) that extends horizontally.

In this configuration, the nozzles 10 of the eight ink-jet heads 11 are arranged over an entire length in the sheet width direction of a recording sheet P. That is, each head unit 2 is a so-called line head. The following explanation is made while defining the right side and the left side in the sheet width direction as indicated in FIG. 1.

The head holding member 12 is a rectangular plate-like member that extends in the sheet width direction and a conveyance direction. The conveyance direction extends horizontally and is orthogonal to the sheet width direction. The head holding member 12 holds the eight ink-jet heads 11. The following explanation is made while defining the front side and the rear side in the conveyance direction as indicated in FIG. 1.

The four head units 2 are arranged in the conveyance direction. A black ink is discharged from the nozzles 10 of a head unit 2 included in the four head units 2 and positioned at the rearmost side. A yellow ink is discharged from the nozzles 10 of a head unit 2 included in the four head units 2 and positioned at the second rearmost side. A cyan ink is discharged from the nozzles 10 of a head unit 2 included in the four head units 2 and positioned at the third rearmost side. A magenta ink is discharged from the nozzles 10 of a head unit 2 included in the four head units 2 and positioned at the frontmost side.

The platen 3 is disposed below the head units 2. The platen 3 extends over the entire length in the sheet width direction of the recording sheet P and extends over the four head units 2 in the conveyance direction. The platen 3 faces the nozzles 10 of the four head units 2 and supports the recording sheet P from below.

The conveyance roller 4 is disposed at the rear side of the four head units 2 and the platen 3. The conveyance roller 5 is disposed at the front side of the four head units 2 and the platen 3. The conveyance rollers 4 and 5 convey the recording sheet P in the conveyance direction.

In the printer 1, inks are discharged from the nozzles 10 of the eight ink-jet heads 11 of the head units 2 while the recording sheet P is conveyed in the conveyance direction by use of the conveyance rollers 4 and 5. Accordingly, recording is performed on the recording sheet P.

<Ink-Jet Head 11>

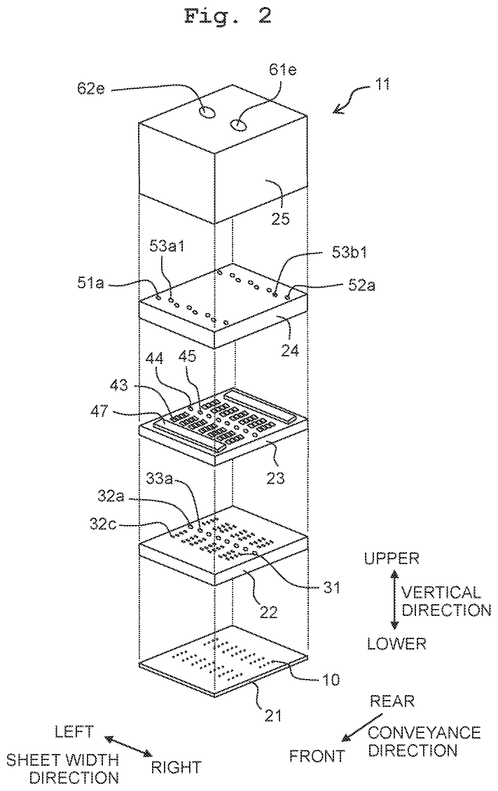

Subsequently, a structure of the ink-jet head 11 is explained. As depicted in FIG. 2, the ink-jet head 11 includes a nozzle member 21, a first common channel member 22, an actuator member 23, a third common channel member 24, and a second common channel member 25. Those members are stacked in a vertical direction (“third direction” of the present disclosure) in this order from below. In the first embodiment, the upper side in the vertical direction corresponds to “one side in the third direction”, and the lower side in the vertical direction corresponds to “the other side in the third direction”.

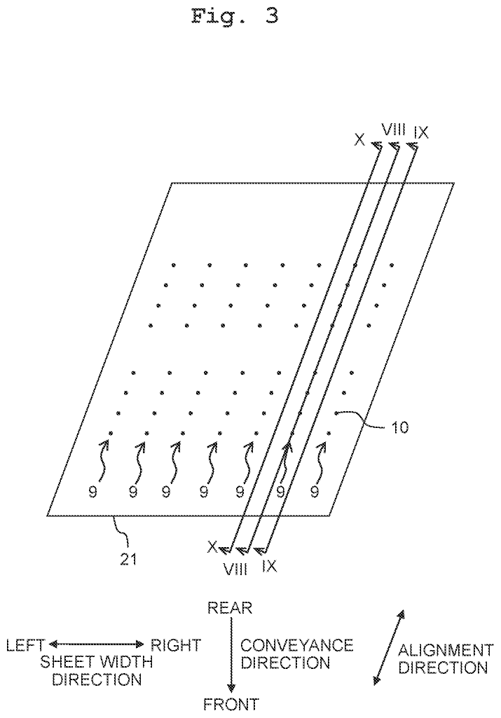

The nozzle member 21, which is formed from a synthetic resin material or the like, is a plate-like member. The thickness (length in the vertical direction) of the nozzle member 21 is approximately 50 to 100 μm. As depicted in FIGS. 2, 3, and 8, seven nozzle rows 9 arranged in the sheet width direction are formed in the nozzle member 21. Each nozzle row 9 includes the nozzles 10 aligned in an alignment direction (“first direction” of the present disclosure). The alignment direction extends horizontally and is inclined to the conveyance direction. In each nozzle row 9, an interval between a nozzle 10 included in the nozzles 10 forming a front-side nozzle group and positioned at the rearmost side and a nozzle 10 included in the nozzles 10 forming a rear-side nozzle group and positioned at the frontmost side is larger than an interval between any other nozzles 10 belonging to each nozzle row 9. Since the nozzles 10 formed in the nozzle member 21 are aligned as described above, the nozzles 10 are arranged at regular intervals in the sheet width direction as view in the conveyance direction.

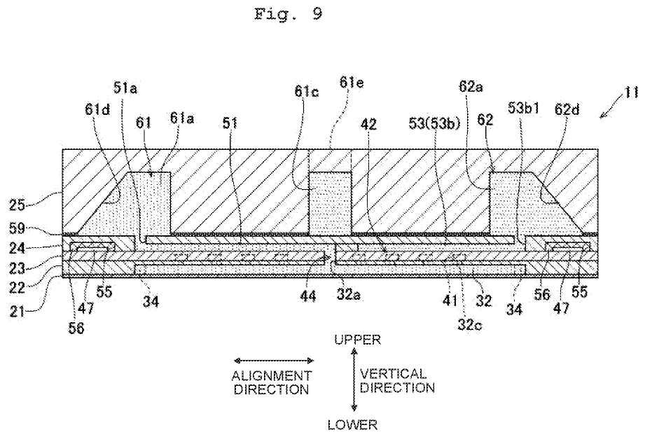

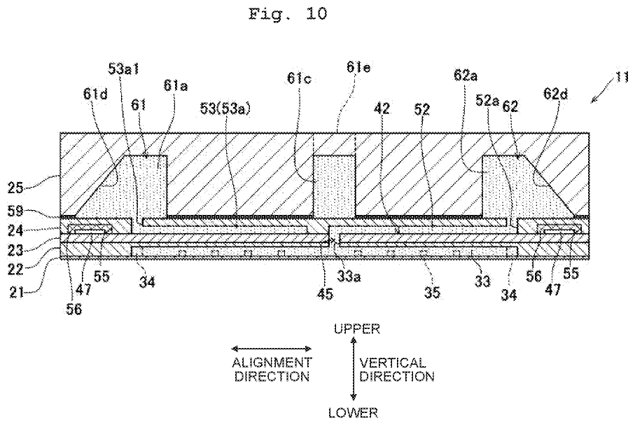

The first common channel member 22 is formed from a metal material or the like. The first common channel member 22 is disposed on an upper surface of the nozzle member 21 As depicted in FIGS. 2, 4, and 8 to 10, the first common channel member 22 includes descenders 31, four first supply channels 32, four first return channels 33, two bypass channels 34, and individual return channels 35.

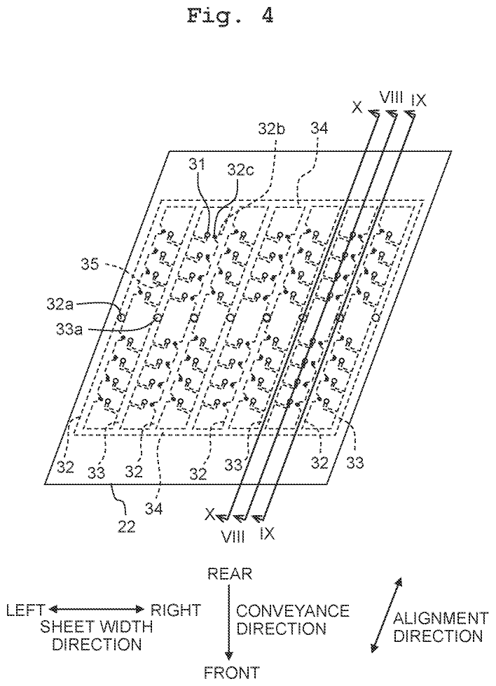

As depicted in FIG. 4, the descenders 31 are formed corresponding to the respective nozzles 10. Each of the descenders 31 overlaps in the vertical direction with the corresponding one of the nozzles 10. The descenders 31 pass through the first common channel member 22 in the vertical direction.

The first supply channels 32, the first return channels 33, and the bypass channels 34 are formed by recesses opened in a lower surface of the first common channel member 22. In the first embodiment, the first common channels 32 and the first return channels 33 correspond to “a plurality of first common channels” of the present disclosure.

The four first supply channels 32 extend in the alignment direction and arranged in the sheet width direction at intervals. A communication opening 32a, which is opened in an upper surface of the first common channel member 22, is provided at a center portion in the alignment direction of each first supply channel 32.

The first supply channel 32 positioned at the leftmost side corresponds to the nozzle row 9 positioned at the leftmost side. The first supply channel 32 that is the second from the left corresponds to the second and third nozzle rows 9 from the left. The first supply channel 32 that is the third from the left corresponds to the fourth and fifth nozzle rows 9 from the left. The first supply channel 32 that is the fourth from the left corresponds to the sixth and seventh nozzle rows 9 from the left. Parts of each first supply channel 32 of which positions in the alignment direction are the same as those of the nozzles 10 forming the corresponding nozzle row(s) 9 are protrusions 32b. The protrusions 32b protrude in a direction that extends horizontally and is orthogonal to the alignment direction. The protrusions 32b are provided with communication openings 32cthat are opened in the upper surface of the first common channel member 22.

The four first return channels 33 extend in the alignment direction. The first return channels 33 and the first supply channels 32 are alternately arranged in the sheet width direction. A communication opening 33a that is opened in the upper surface of the first common channel member 22 is provided at a center portion in the alignment direction of each first return channel 33.

The first return channel 33 positioned at the leftmost side corresponds to the first and second nozzle rows 9 from the left. The first return channel 33 that is the second from the left corresponds to the third and fourth nozzle rows 9 from the left. The first return channel 33 that is the third from the left corresponds to the fifth and sixth nozzle rows 9 from the left. The first return channel 33 positioned at the rightmost side corresponds to the nozzle row 9 positioned at the rightmost side.

The two bypass channels 34 extend in the sheet width direction. One of the bypass channels 34 connects front ends of the four first supply channels 32 and front ends of the four first return channels 33. The other of the bypass channels 34 connects rear ends of the four first supply channels 32 and rear ends of the four first return channels 33.

The individual return channels 35 are provided corresponding to the respective descenders 31. Each of the individual return channels 35 is connected to a lower end of the corresponding one of the descenders 31. Each individual return channel 35 extends toward the front-left side in the alignment direction from the connection portion with the descender 31, is bent in the direction that extends horizontally and is orthogonal to the alignment direction, and then is connected to the first return channel 33.

The actuator member 23 is formed from silicon or the like. The actuator member 23 is disposed on the upper surface of the first common channel member 22. As depicted in FIGS. 2, 5, 8 to 10, the actuator member 23 includes pressure chambers 41, a vibration plate 42, driving elements 43, four supply communication channels 44, and four return communication channels 45.

The pressure chambers 41 correspond to the respective nozzles 10. The pressure chambers 41 are formed by recesses that are opened in a lower surface of the actuator member 23. Each pressure chamber 41 has a rectangular shape of which longitudinal direction is the direction that extends horizontally and is orthogonal to the alignment direction. A center portion in the longitudinal direction and the alignment direction of each of the pressure chambers 41 overlaps in the vertical direction with the corresponding one of the nozzles 10 and descenders 31. This allows each of the nozzles 10 to communicate with the corresponding one of the pressure chambers 41 via the descender 31.

An end at one side in the longitudinal direction of each pressure chamber 41 overlaps in the vertical direction with the communication opening 32c. This allows the pressure chambers 41 to communicate with the corresponding first supply channel 32 via the communication openings 32c. In the pressure chambers 41 corresponding to odd-numbered nozzle rows 9 from the left in the sheet width direction, the one side in the longitudinal direction of each pressure chamber 41 corresponds to the left-rear side. In the pressure chambers 41 corresponding to even-numbered nozzle rows 9 from the left in the sheet width direction, the one side in the longitudinal direction of each pressure chamber 41 corresponds to the right-front side.

In the ink-jet heads 11, each individual channel 40 is formed by the nozzle 10, the descender 31 corresponding to the nozzle 10, the individual return channel 35, and the pressure chamber 41.

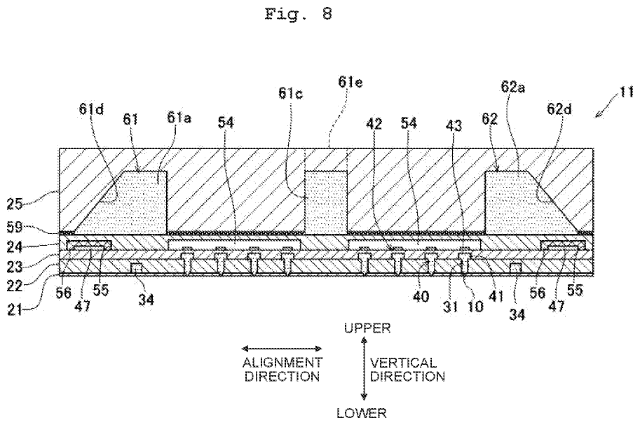

As depicted in FIG. 8, the vibration plate 42 is formed by an upper end of the actuator member 23. The vibration plate 42 continuously extends over the pressure chambers 41 to cover the pressure chambers 41. The driving elements 43 correspond to the respective pressure chambers 41. The driving elements 43 are arranged at portions included in an upper surface of the vibration plate 42 and overlapping in the vertical direction with center portions of the respective pressure chambers 41. Each driving element 43 is, for example, a piezoelectric element having a piezoelectric body and an electrode, The driving element 43 deforms a part of the vibration plate 42 that overlaps in the vertical direction with the pressure chamber 41. This applies pressure to ink in the pressure chamber 41 (this applies discharge energy to ink in the individual channel 40), thereby discharging ink from the nozzle 10 that communicates with the pressure chamber 41.

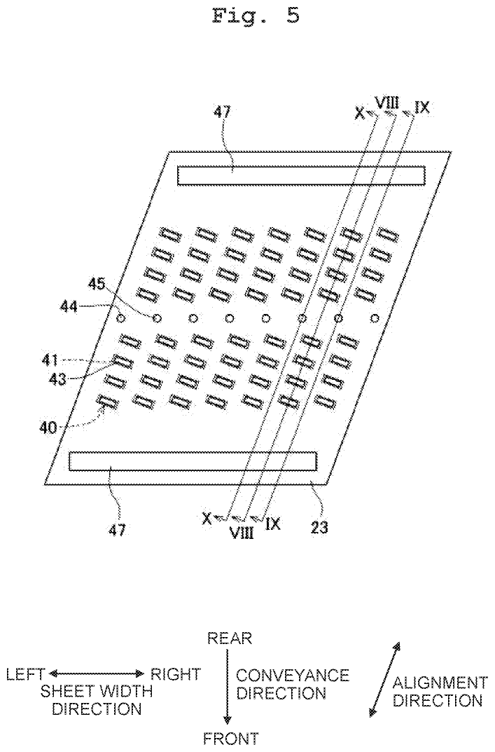

As depicted in FIG. 5, the four supply communication channels 44 correspond to the four first supply channels 32. Each of the supply communication channels 44 overlaps in the vertical direction with the communication opening 32a of the corresponding one of the first supply channels 32. The supply communication channels 44 pass through the actuator member 23 to extend in the vertical direction. Lower ends of the supply communication channels 44 are connected to the respective communication openings 32a.

The four return communication channels 45 correspond to the four first return channels 33. Each of the return communication channels 45 overlaps in the vertical direction with the communication opening 33a of the corresponding one of the first return channels 33. The return communication channels 45 pass through the actuator member 23 to extend in the vertical direction. Lower ends of the return communication channels 45 are connected to the respective communication openings 33a.

The driver ICs 47 are placed at both ends in the conveyance direction of an upper surface of the actuator member 23. The driver ICs 47 are arranged such that its longitudinal direction corresponds to the sheet width direction. The driver IC 47 disposed at the front side is connected to driving elements 43 included in the driving elements 43 and forming a front-side driving element group via traces or the like (not depicted). The driver IC 47 disposed at the front side drives the driving elements 43 forming the front-side driving element group. The driver IC 47 disposed at the rear side is connected to driving elements 43 included in the driving elements 43 and forming a rear-side driving element group via traces or the like (not depicted). The driver IC 47 disposed at the rear side drives the driving elements 43 forming the rear-side driving element group.

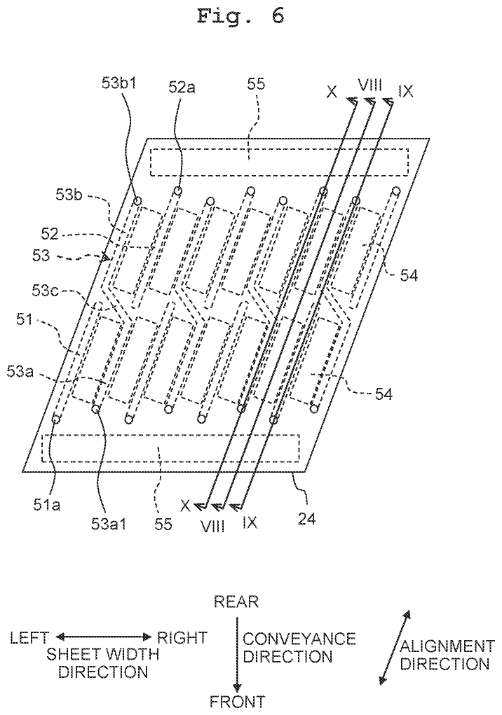

The third common channel member 24 is formed from a synthetic resin material or the like, The third common channel member 24 is disposed on the upper surface of the actuator member 23. As depicted in FIGS. 2, 6, and 8 to 10, the third common channel member 24 includes four third supply channels 51, four third return channels 52, four bypass channels 53, fourteen element accommodating portions 54, and two IC accommodating portions 55. The third supply channels 51, the third return channels 52, the bypass channels 53, the element accommodating portions 54, and the IC accommodating portions 55 are formed by recesses that are opened in a lower surface of the third common channel member 24. In the first embodiment, the third supply channels 51 and the third return channels 52 correspond to “a plurality of third common channels” of the present disclosure.

The four third supply channels 51 correspond to the four first supply channels 32, Each of the third supply channels 51 extends in the alignment direction over approximately a front half portion of the corresponding one of the first supply channels 32. An end at the right-rear side of each of the third supply channels 51 is connected to the corresponding one of the supply communication channels 44. An end at the left-front side of each of the third supply channels 51 extending in the alignment direction is formed having a communication opening 51a that is opened in an upper surface of the third common channel member 24.

The four third return channels 52 correspond to the four first return channels 33. Each of the third return channels 52 extends in the alignment direction over approximately a rear half portion of the corresponding one of the first return channels 33. An end at the left-front side of each of the third return channels 52 is connected to the corresponding one of the return communication channels 45. An end at the right-rear side of each of the third return channels 52 extending in the alignment direction is formed having a communication opening 52a that is opened in an upper surface of the third common channel member 24.

Each of the four bypass channels 53 includes channel portions 53a to 53c.

The four channel portions 53a forming the four bypass channels 53 extend in the alignment direction. The channel portions 53a and the third supply channels 51 are arranged alternately in the sheet width direction. Each channel portion 53a is positioned on an extension line of the third return channel 52 in the alignment direction. An end at the left-front side of the channel portion 53a extending in the alignment direction is formed having a communication opening 53a1 that is opened in the upper surface of the third common channel member 24.

The four channel portions 53b forming the four bypass channels 53 extend in the alignment direction. The channel portions 53b and the third return channels 52 are arranged alternately in the sheet width direction. Each channel portion 53b is positioned on an extension line of the third supply channel 51 in the alignment direction. An end at the right-rear side of the channel portion 53b extending in the alignment direction is formed having a communication opening 53b1 that is opened in the upper surface of the third common channel member 24.

The four channel portions 53c forming the four bypass channels 53 connect the ends at the right-rear side of the channel portions 53a and the ends at the left-front side of the channel portions 53b.

The fourteen element accommodating portions 54 correspond to the seven nozzle rows 9. Two element accommodating portions 54 included in the fourteen element accommodating portions 54 correspond to one nozzle row 9 included in the seven nozzle rows 9. The two element accommodating portions 54 corresponding to one nozzle row 9 overlap in the vertical direction with driving elements 43 that are included in the driving elements 43 corresponding to one nozzle row 9 and that form the front-side driving element group and driving elements 43 that are included in the driving elements 43 corresponding to one nozzle row 9 and that form the rear-side driving element group. Thus, half of the driving elements 43 corresponding to one nozzle row 9 are accommodated in the corresponding one of the elements accommodating portions 54.

The two IC accommodating portions 55 overlap in the vertical direction with the two driver ICs 47. Each of the driver ICs 47 is accommodated in the corresponding one of the IC accommodating portions 55. In the above arrangement of the two IC accommodating portions 55, the third supply channels 51, the third return channels 52, the bypass channels 53, and the element accommodating portions 54 are arranged in the third common channel member 24 such that they are interposed between the respective IC accommodating portions 55 in the alignment direction. Each of the IC accommodating portions 55 includes a thermal conductive member 56 having higher thermal conductivity than air. The thermal conductive member 56 is interposed between the driver IC 47 and the third common channel member 24. The thermal conductive member 56 is formed from, for example, epoxy-based adhesive.

The second common channel member 25 is formed from a material having higher thermal conductivity than the third common channel member 24, such as alumina. As depicted in FIGS. 8 to 10, the second common channel member 25 adheres to the upper surface of the third common channel member 24 by adhesive 59. The adhesive 59 is, for example, epoxy-based adhesive. The adhesive 59 has higher thermal conductivity than the third common channel member 24. The nozzle member 21 adheres to the first common channel member 22 by adhesive, the first common channel member 22 adheres to the actuator member 23 by adhesive, and the actuator member 23 adheres to the third common channel member 24 by adhesive. However, illustration of the adhesive is omitted in FIGS. 8 to 10.

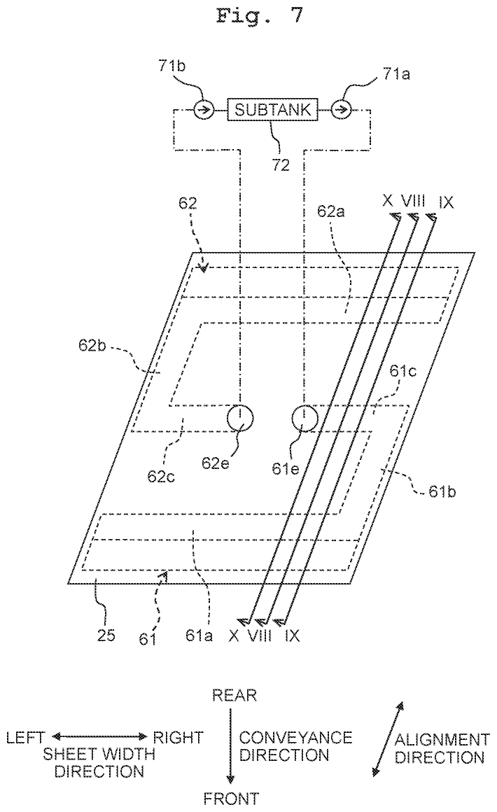

As depicted in FIGS. 2 and 7 to 10, the second common channel member 25 includes a second common channel 61 and a second return channel 62. The second supply channel 61 and the second return channel 62 are formed by recesses formed in a lower surface of the second common channel member 25. In the first embodiment, the second supply channel 61 and the second return channel 62 correspond to a “second common channel” of the present disclosure.

The second common channel 61 has channel portions 61a to 61c. in a front portion of the second common channel member 25, the channel portion 61a extends in the sheet width direction over the four communication openings 51 and the four communication openings 53a1. The channel portion 61a is connected to the communication openings 51a and 53a1. Further, a lower portion of the channel portion 61a extends frontward (toward the front-left side in the alignment direction) beyond an upper portion of the channel portion 61a. The lower portion of the channel portion 61a overlaps in the vertical direction with the driver IC 47 positioned at the front side. In the alignment direction, the lower portion of the channel portion 61a does not extend to a position overlapping in the vertical direction with a part of the third common channel member 24 that is outside the driver IC 47. That is, the channel portion 61a does not overlap in the vertical direction with the part of the third common channel member 24 that is outside the driver IC 47. In the first embodiment, the left-front side in the alignment direction of the channel portion 61a corresponds to “one side in the first direction” of the present disclosure. The right-rear side in the alignment direction corresponds to “the other side in the first direction” of the present disclosure.

An inner wall surface 61d positioned at the front side (left-front side in the alignment direction) of the channel portion 61a is inclined to the vertical direction so that an upper portion thereof (“one side in the first direction” of the present disclosure) is positioned at the rear side (right-rear side in the alignment direction) of a lower portion thereof.

The channel portion 61b is connected to a right end of the channel portion 61a. The channel portion 61b extends in the alignment direction from the connection portion with the channel portion 61a to a center portion in the conveyance direction of the ink-jet head 11. The channel portion 61c is connected to a rear end of the channel portion 61b. The channel portion 61c extends leftward from the connection portion with the channel portion 61b. A left end of the channel portion 61c is formed having a supply opening 61e that is opened in an upper surface of the second common channel member 25.

The supply opening 61e is connected to a subtank 72 via a pump 71a. The pump 71a feeds ink from the subtank 72 toward the supply opening 61e. The subtank 72 is connected to a main tank (not depicted), such as an ink cartridge, via a tube (not depicted) and ink is supplied from the main tank.

The second return channel 62 has channel portions 62a to 62c. In a rear portion of the second common channel member 25, the channel portion 62a extends in the sheet width direction over the four communication openings 52a and the four communication openings 53b1. The channel portion 62a is connected to the communication openings 52a and 53b1. A lower portion of the channel portion 62a extends rearward (toward the right-rear side in the alignment direction) beyond an upper portion of the channel portion 62a. The lower portion of the channel portion 62a overlaps in the vertical direction with the driver IC 47 disposed at the rear side. The lower portion of the channel portion 62a does not extend in the alignment direction to a position overlapping in the vertical direction with a part of the third common channel member 24 that is outside the driver IC 47. That is, the channel portion 62a does not overlap in the vertical direction with the part of the third common channel member 24 that is outside the driver IC 47. In the first embodiment, the right-rear side in the alignment direction of the channel portion 62a corresponds to “one side in the first direction” of the present disclosure. The left-front side in the alignment direction of the channel portion 62a corresponds to “the other side in the first direction” of the present disclosure.

An inner wall surface 62d positioned at the rear side (right-rear side in the alignment direction) of the channel portion 62a is inclined to the vertical direction so that an upper portion thereof is positioned at the front side (left-front side in the alignment direction) of a lower portion thereof.

The channel portion 62b is connected to a left end of the channel portion 62a. The channel portion 62b extends in the alignment direction from the connection portion with the channel portion 62a to the center portion in the conveyance direction of the ink-jet head 11. The channel portion 62c is connected to a front end of the channel portion 62b. The channel portion 62c extends rightward from the connection portion with the channel portion 62b. A right end of the channel portion 62c is formed having a discharge opening 62e that is opened in the upper surface of the second common channel member 25.

The discharge opening 62e is connected to the subtank 72 via the pump 71b. The pump 71b feeds ink from the discharge opening 62e toward the subtank 72.

Driving the pumps 71a and 71b causes ink in the subtank 72 to flow into the second supply channel 61 from the supply opening 61e. Part of the ink in the second supply channel 61 flows into the third supply channels 51 from the communication openings 51a. A residual ink in the second supply channel 61 flows into the bypass channels 53 from the communication openings 53a1.

Ink in the third supply channels 51 flows into the supply communication channels 44, and then flows into the first supply channels 32 from the communication openings 32a. Part of the ink in the first supply channels 32 flows into the individual channels 40. Ink in the individual channels 40 flows into the first return channels 33 adjacent to the first supply channels 32 in the sheet width direction. A residual ink in the first supply channels 32 flows, via the bypass channels 34, into the first return channels 33 that are adjacent to the first supply channels 32 in the sheet width direction.

Ink in the first return channels 33 flows into the return communication channels 45 from the communication openings 33a, and then flows into the third return channels 52. Ink in the third return channels 52 flows from the communication openings 52a into the second return channel 62. Ink in the bypass channels 53 flows from the communication openings 53b1 into the second return channel 62. Ink in the second return channel 62 is discharged from the discharge opening 62e and returns to the subtank 72.

In the first embodiment, ink flows as described above by driving the pumps 71a and 71b, and thus ink circulates between the ink-jet head 11 and the subtank 72. Only one of the pumps 71a and 71b may be provided. Also in this case, ink can circulate between the ink-jet head 11 and the subtank 72 similarly to the above configuration by driving one of the pumps.

<Effects of First Embodiment>

As depicted in FIG. 8, in the first embodiment, the second supply channel 61 and the second return channel 62 formed in the second common channel member 25 overlap in the vertical direction with the driver ICs 47. Thus, heat generated in the driver ICs 47 can be released efficiently via ink flowing through the second supply channel 61 and the second return channel 62.

In the first embodiment, the second common channel member 25 adheres to the upper surface of the third common channel member 24. The second supply channel 61 and the second return channel 62 are formed by recesses that are opened in the lower surface of the second common channel member 25. The channel portion 61a of the second supply channel 61 and the channel portion 62a of the second return channel 62 do not overlap in the vertical direction with the parts of the third common channel member 24 that are outside the respective driver ICs 47 in the conveyance direction (alignment direction). In this configuration, parts of the second common channel member 25 that are outside the respective driver ICs 47 in the conveyance direction (alignment direction) can adhere to (are connected to) the third common channel member 24. This inhibits ink in the second supply channel 61 and the second return channel 62 from leaking through the adhering portion (connection portion) between the third common channel member 24 and the second common channel member 25.

In the first embodiment, the lower portion of the channel portion 61a of the second supply channel 61 extends frontward (toward the left-front side in the alignment direction) beyond the upper portion thereof. The lower portion of the channel portion 61a of the second supply channel 61 overlaps in the vertical direction with the driver IC 47. The inner wall surface 61d at the front side of the channel portion 61a is inclined to the vertical direction so that the upper portion thereof is positioned at the rear side (right-rear side in the alignment direction) of the lower portion thereof. In this configuration, air bubbles present at the part of the channel portion 61a that overlaps in the vertical direction with the driver IC 47 are likely to move upward along the inner wall surface 61d. Thus, air bubbles are not likely to accumulate in the part of the channel portion 61a that overlaps in the vertical direction with the driver IC 47.

Similarly, in the first embodiment, the lower portion of the channel portion 62a of the second return channel 62 extends rearward (toward the right-rear side in the alignment direction) beyond the upper portion thereof. The lower portion of the channel portion 62a of the second return channel 62 overlaps in the vertical direction with the driver IC 47. The inner wall surface 62d at the rear side of the channel portion 62a is inclined to the vertical direction so that the upper portion thereof is positioned at the front side (left-front side in the alignment direction) of the lower portion thereof. In this configuration, air bubbles present at the part of the channel portion 62a that overlaps in the vertical direction with the driver IC 47 are likely to move upward along the inner wall surface 62d. Thus, air bubbles are not likely to accumulate in the part of the channel portion 62a that overlaps in the vertical direction with the driver IC 47.

In the first embodiment, the first common channel member 22 is formed having the first supply channels 32 and the first return channels 33. The third common channel member 24 is formed having the third supply channels 51 and the third return channels 52. The second common channel member 25 is formed having the second supply channel 61 and the second return channel 62. Ink flows through those channels, thereby circulating ink between the ink-jet head 11 and the subtank 72. Thus, heat generated in the driver ICs 47 can be efficiently released to the outside of the ink-jet head 11 via ink circulating between the ink-jet head 11 and the subtank 72.

In the first embodiment, the second common channel member 25 is formed from a material having higher thermal conductivity than the third common channel member 24. Thus, beat transmitted from the driver ICs 47 to the third common channel member 24 is efficiently transmitted to the second common channel member 25. As a result, heat generated in the driver ICs 47 can be efficiently released via ink in the second supply channel 61 and the second return channel 62 formed in the second common channel member 25.

In the first embodiment, the adhesive 59 by which the third common channel member 24 adheres to the second common channel member 25 has higher thermal conductivity than the third common channel member 24. Thus, beat transmitted from the driver ICs 47 to the third common channel member 24 can be efficiently transmitted to the second common channel member 25. As a result, heat generated in the driver ICs 47 can he efficiently released via ink in the second supply channel 61 and the second return channel 62 formed in the second common channel member 25.

Further, in the first embodiment, the thermal conductive members 56 are provided in the IC accommodating portions 55. The thermal conductive members 56 are interposed between the driver ICs 47 and the third common channel member 24. Thus, heat generated in the driver ICs 47 can be efficiently transmitted to the third common channel member 25.

In the first embodiment, the third supply channels 51, the third return channels 52, and the bypass channels 53 are arranged in the third common channel member 24 such that they are interposed between the respective IC accommodating portions 55 in the conveyance direction (alignment direction). Thus, in the third common channel member 24, the third supply channels 51, the third return channels 52, and the bypass channels 53 do not overlap in the vertical direction with and the IC accommodating portions 55, resulting in a sufficient thickness (length in the vertical direction) of the third common channel member 24, This improves the strength of the third common channel member 24.

### Second Embodiment

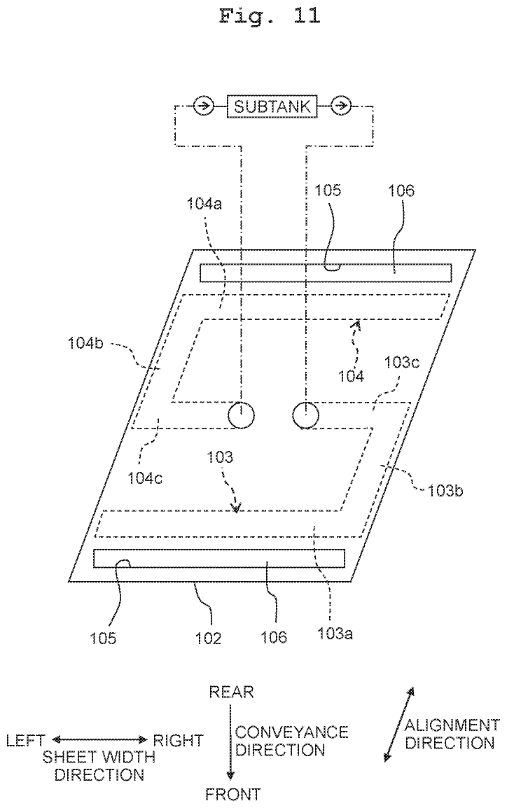

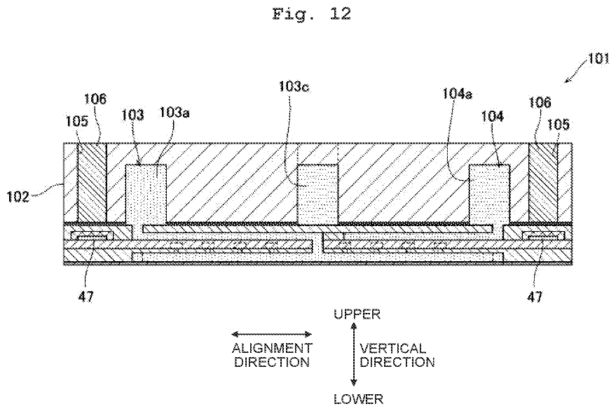

Subsequently, a second embodiment of the present disclosure is explained. As depicted in FIGS. 11 and 12, a structure of a second common channel member 102 of an ink-jet head 101 according to the second embodiment is different from that of the second common channel member 25 of the ink-jet head 11 according to the first embodiment.

More specifically, the second common channel member 102 includes a second supply channel 103 and a second return channel 104. The second supply channel 103 has channel portions 103a to 103c. The channel portions 103a to 103c are similar to the channel portions 61a to 61c. However, unlike the channel portion 61a, a length in the conveyance direction (alignment direction) of the channel portion 103a is constant over its entire area in the vertical direction. The channel portion 103a does not overlap in the vertical direction with the driver IC 47.

The second return channel 104 has channel portions 104a to 104c. The channel portions 104a to 104c are similar to the channel portions 62a to 62c. However, unlike the channel portion 62a, a length in the conveyance direction (alignment direction) of the channel portion 104a is constant over its entire area in the vertical direction. The channel portion 104a does not overlap in the vertical direction with the driver IC 47.

The second common channel member 102 is formed having two through holes 105 that correspond to the two driver ICs 47. The through holes 105 are formed at parts of the second common channel member 102 that overlap in the vertical direction with the respective driver ICs 47. The through holes 105 pass through the second common channel member 102 to extend in the vertical direction. Upper ends of the through holes 105 communicate with air. Heat sinks 106 formed from a metal material such as aluminum are arranged in the through holes 105. In the second embodiment, the through holes 105 and the heat sinks 106 correspond to a “chiller” of the present disclosure.

<Effects of Second Embodiment>

In the second embodiment, the through holes 105 are formed in the parts of the second common channel member 102 that overlap in the vertical direction with the driver ICs 47. The heat sinks 106 are arranged in the through holes 105. Thus, heat generated in the driver ICs 47 can efficiently released via the heat sinks 106 in the through holes 105.

In the second embodiment, the holes forming the chiller are the through holes 105. The through holes 105 pass through the second common channel member 102 in the vertical direction and the upper ends thereof communicate with air. Thus, heat generated in the driver ICs 47 can be efficiently released via the heat sinks 106 in the through holes 105.

### Modified Embodiments

The first and second embodiments of the present disclosure are explained above, The present disclosure, however, is not limited thereto. The present disclosure may be changed or modified without departing from the gist and the scope of the claims below.

In the first embodiment, the lower portion of the channel portion 61a of the second supply channel 61 extends frontward beyond the upper portion thereof, and overlaps in the vertical direction with the driver IC 47. The inner wall surface 61d at the front side of the channel portion 61a is inclined to the vertical direction so that the upper portion thereof is positioned at the rear side of the lower portion thereof. The lower portion of the channel portion 62a of the second return channel 62 extends rearward beyond the upper portion thereof, and overlaps in the vertical direction with the driver IC 47. The inner wall surface 62d at the rear side of the channel portion 62a is inclined to the vertical direction so that the upper portion thereof is positioned at the front side of the lower portion thereof. The present disclosure, however, is not limited to this aspect.

The inner wall surface at the front side of the channel portion 61a may be a surface having a stepped portion in which its lower portion is positioned at the front side of its upper portion. The inner wall surface at the rear side of the channel portion 62a may be a surface having a stepped portion in which its lower portion is positioned at the rear side of its upper portion.

The channel portion 61a may extend over an area overlapping in the vertical direction with the communication openings 51a, 53a1 and an area overlapping in the vertical direction with the driver IC 47. The length in the conveyance direction of the channel portion 61a may be constant regardless of the position in the vertical direction. The inner wall surface at the front side of the channel portion 61a may extend parallel to the vertical direction. The channel portion 62a may extend over an area overlapping in the vertical direction with the communication openings 52a, 53b1 and an area overlapping in the vertical direction with the driver IC 47. The length in the conveyance direction of the channel portion 62a may be constant regardless of the position in the vertical direction. The inner wall surface at the rear side of the channel portion 62a may extend parallel to the vertical direction.

In the first embodiment, the channel portion 61a of the second supply channel 61 and the channel portion 62a of the second return channel 62 do not overlap in the vertical direction with the parts of the third common channel member 24 that are outside the driver ICs 47 in the conveyance direction (alignment direction). The aspects of the present disclosure, however, are not limited thereto. At least one of the channel portion 61a and the channel portion 62a may overlap in the vertical direction with the part of the third common channel member 24 that is outside the corresponding driver IC 47 in the conveyance direction (alignment direction).

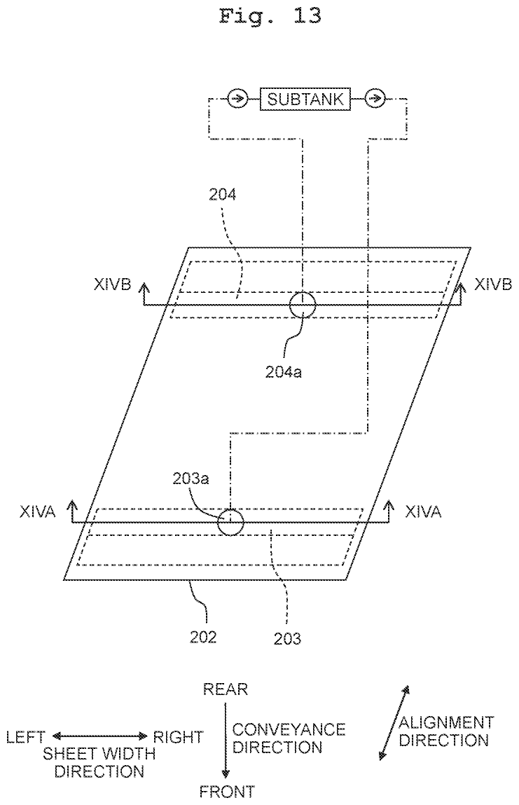

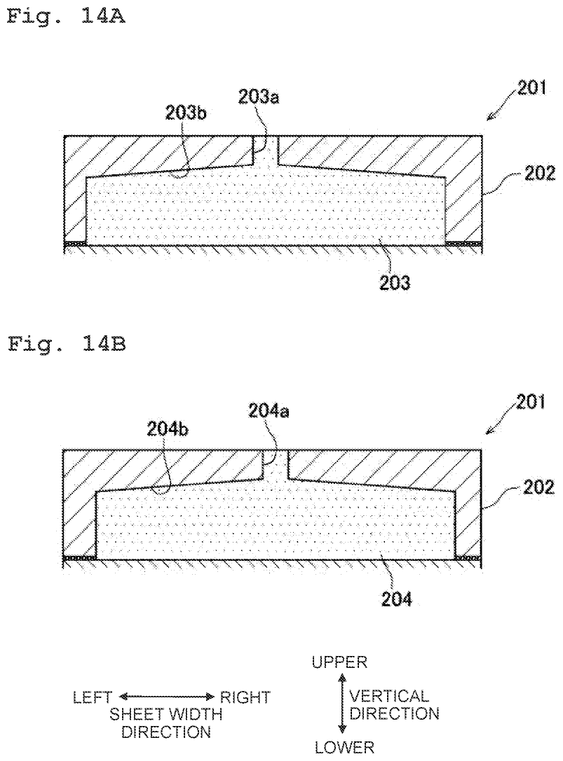

In the first embodiment, ceiling surfaces of the second supply channel 61 and the second return channel 62 (inner wall surfaces at the upper side) are horizontal surfaces. The aspects of the present disclosure, however, are not limited thereto. As depicted in FIGS. 13 and 14, in an inkjet head 201 according to a modified embodiment, a second common channel member 202 includes a second supply channel 203 and a second return channel 204.

The second supply channel 203 is similar to the channel portion 61a of the first embodiment. The second supply channel 203 extends in the sheet width direction. A supply opening 203a, which is opened in an upper surface of the second common channel member 202, is provided at a center portion in the sheet width direction of the second supply channel 201 A ceiling surface 203b of the second supply channel 203 is inclined to the sheet width direction so that a portion closer to the supply opening 203a in the sheet width direction is positioned at the upper side of a portion farther from the supply opening 203a in the sheet width direction.

The second return channel 204 is similar to the channel portion 62a of the first embodiment. The second return channel 204 extends in the sheet width direction. A discharge opening 204a, which is opened in the upper surface of the second common channel member 202, is provided at a center portion in the sheet width direction of the second return channel 204. A ceiling surface 204b of the second return channel 204 is inclined to the sheet width direction so that a portion closer to the discharge opening 204a in the sheet width direction is positioned at the upper side of a portion farther from the discharge opening 204a in the sheet width direction.

In this modified embodiment, air bubbles in the second supply channel 203 are guided to the supply opening 203a along the ceiling surface 203b, and thus air bubbles are easily discharged to the outside through the supply opening 203a. This inhibits air bubbles from accumulating in the second supply channel 203.

In this modified embodiment, air bubbles in the second return channel 204 are guided to the discharge opening 204a along the ceiling surface 204b, and thus air bubbles are easily discharged to the outside through the discharge opening 204a. This inhibits air bubbles from accumulating in the second return channel 204.

In the above modified embodiment, the supply opening 203a is provided at the center portion in the sheet width direction of the second supply channel 203, and the discharge opening 204a is provided at the center portion in the sheet width direction of the second return channel 204. The aspects of the present disclosure, however, are not limited thereto. The supply opening 203a may be provided at another portion of the second supply channel 203, such as an end in the sheet width direction of the second supply channel 203. Further, the discharge opening 204a may be provided at another portion of the second return channel 204, such as an end in the sheet width direction of the second return channel 204.

In the above modified embodiment, the ceiling surfaces 203b and 204b are inclined to the sheet width direction. The aspects of the present disclosure, however, are not limited thereto. Only one of the ceiling surfaces 203b and 204b may be inclined to the sheet width direction, and the other may be a horizontal surface.

In the first embodiment, the first common channel member 22 is formed having the first supply channels 32 and the first return channels 33. The third common channel member 24 is formed having the third supply channels 51 and the third return channels 52. The second common channel member 25 is formed having the second supply channel 61 and the second return channel 62. Accordingly, ink can circulate between the ink-jet head 11 and the subtank 72. The aspects of the present disclosure, however, are not limited thereto.

For example, the channels for supplying ink from the subtank 72 to the individual channels 40 may be formed in the first common channel member 22, the third common channel member 24, and the second common channel member 25. The channels for returning ink from the individual channels 40 to the subtank 72 may not be formed in the first common channel member 22, the third common channel member 24, and the second common channel member 25. In this case, the channels that are formed in the first common channel member 22, the third common channel member 24, and the second common channel member 25 and that supply ink from the subtank 72 to the individual channels 40 correspond to the “first common channels”, “third common channels”, and “second common channel” of the present disclosure.

In the second embodiment, the holes formed in the second common channel member 102 are the through holes 105. The through holes 105 pass through the second common channel member 102 in the vertical direction and the upper ends thereof communicate with air. The aspects of the present disclosure, however, are not limited thereto. Instead of the through holes 105, the second common channel member 102 may he formed having holes that are opened only in the lower surface thereof.

In the second embodiment, the heat sinks 106 are arranged in the through holes 105. The aspects of the present disclosure, however, are not limited thereto. For example, no heat sinks may be provided in the through holes 105. Also in this case, heat generated in the driver ICs can be released efficiently through the through holes 105.

The second common channel member 102 may not be formed having any holes for placing the heat sinks. The heat sinks may be arranged on an end surface in the conveyance direction (alignment direction) of the second common channel member 102. The heat sinks may overlap in the vertical direction with the driver ICs 47.

In the first and second embodiments, the third supply channels 51, the third return channels 52, and the bypass channels 53 are arranged in the third common channel member 24 such that they are interposed between the respective IC accommodating portions 55 in the conveyance direction (alignment direction). The aspects of the present disclosure, however, are not limited thereto. For example, the third supply channels 51, the third return channels 52 and the bypass channels 53 may be formed in the third common channel member 24 at the upper side of the element accommodating portions 54 and the IC accommodating portions 55. The third supply channels 51, the third return channels 52, and the bypass channels 53 may overlap in the vertical direction with the IC accommodating portions 55.

In the first and second embodiments, the thermal conductive members 56 are provided in the IC accommodating portions 55. The aspects of the present disclosure, however, are not limited thereto. The thermal conductive members 56 may not be provided in the IC accommodating portions 55.

In the first and second embodiments, the adhesive by which the second common channel member adheres to the third common channel member has higher thermal conductivity than the third common channel member. The aspects of the present disclosure, however, are not limited thereto, The thermal conductivity of the adhesive may be equal to or less than the thermal conductivity of the third common channel member.

In the first and second embodiments, the second common channel member is formed from a material having higher thermal conductivity than the third common channel member. The aspects of the present disclosure, however, are not limited thereto. The second common channel member and the third common channel member may be formed from the same material. Or, the second common channel member may be formed from a material having lower thermal conductivity than the third common channel member.

In the above examples, the third common channel member is disposed between the actuator member and the second common channel member. The channels formed in the first common channel member communicate with the channels formed in the second common channel member via the channels formed in the third common channel member. The aspects of the present disclosure, however, are not limited thereto. For example, the ink-jet head may not include the third common channel member. The second common channel member may be joined directly to the upper surface of the actuator member on which the driver ICs are placed.

The above explanation is made about the examples in which the present disclosure is applied to the ink-jet head of the line type. The aspects of the present disclosure, however, are not limited thereto. For example, the present disclosure can be applied to a so-called serial head that is carried on a carriage and in which ink is discharged from nozzles during its movement together with the carriage.

The above explanation is made about the examples in which the present disclosure is applied to the ink-jet head in which ink is discharged from nozzles. The aspects of the present disclosure, however, are not limited thereto. The present disclosure can be applied to a liquid discharge head that discharges any other liquid than ink.

What is claimed is:

1. A liquid discharge head comprising:
a nozzle member including a plurality of nozzle rows, each of the nozzle rows including a plurality of nozzles aligned in a first direction, the nozzle rows being arranged in a second direction intersecting with the first direction;
a first common channel member disposed at one side of the nozzle member in a third direction orthogonal to the first direction and the second direction, the first common channel member including a plurality of first common channels that correspond to the respective nozzle rows, each of the first common channels extending in the first direction, the first common channels being arranged in the second direction;
an actuator member disposed on a surface at the one side in the third direction of the first common channel member;
the actuator member including:
a plurality of pressure chambers corresponding to the respective nozzles, each of the pressure chambers communicating with a corresponding one of the nozzles and a corresponding one of the first common channels; and
a plurality of driving elements corresponding to the pressure chambers, each of the driving elements configured to apply pressure to a liquid in a corresponding one of the pressure chambers;
a driver IC disposed on a surface at the one side in the third direction of the actuator member and configured to drive the driving elements;
a second common channel member disposed at the one side in the third direction of the actuator member and including a second common channel that is provided in common to the first common channels, extends in the second direction, and communicates with the first common channels; and
a chiller disposed at a part of the second common channel member that overlaps in the third direction with the driver IC and configured to chill the driver IC.

2. The liquid discharge head according to claim 1, wherein the second common channel overlaps in the third direction with the driver IC, and
wherein the chiller contains the liquid in the second common channel.

3. The liquid discharge head according to claim 2, further comprising:
a third common channel member disposed between the actuator member and the second common channel member in the third direction,
wherein the third common channel member includes:
a plurality of third common channels corresponding to the first common channels and arranged in the second direction, each of the third common channels extending in the first direction and communicating with a corresponding one of the first common channels and the second common channel; and
an IC accommodating portion configured to accommodate the driver IC,
wherein the second common channel member adheres to a surface at the one side in the third direction of the third common channel member,
wherein the second common channel is formed by a recess that is opened in a surface at the other side in the third direction of the second common channel member, and
wherein the second common channel does not overlap in the third direction with a part of the third common channel member that is outside the driver IC in the first direction.

4. The liquid discharge head according to claim 2, wherein the third direction is a vertical direction of which upper side is the one side,
wherein a lower portion of the second common channel extends toward one side in the first direction beyond an upper portion of the second common channel, and the lower portion of the second common channel overlaps in the third direction with the driver IC, and
wherein a wall surface defining an end at the one side in the first direction of the second common channel is inclined to the vertical direction so that an upper portion thereof is positioned at the other side in the first direction of a lower portion thereof.

5. The liquid discharge head according to claim 2, further comprising: a plurality of individual channels each of which includes one of the nozzles and one of the pressure chambers,
wherein the first common channels include:
a plurality of first supply channels through which the liquid is supplied to a plurality of individual channels included in the individual channels and corresponding thereto; and
a plurality of first return channels through which the liquid flows out of a plurality of individual channels included in the individual channels and corresponding thereto,
wherein the second common channel includes:
a second supply channel provided in common to the first supply channels and communicating with the first supply channels; and
a second return channel provided in common to the first return channels and communicating with the first return channels.

6. The liquid discharge head according to claim 5, wherein the third direction is a vertical direction of which upper side is the one side,
wherein the second common channel member includes:
a supply opening through which the liquid is supplied to the second supply channel; and
a discharge opening through which the liquid is discharged from the second return channel,
wherein the supply opening is provided in a wall surface at the upper side of the second supply channel, and
wherein the wall surface at the upper side of the second supply channel is inclined to the second direction so that a part of the wall surface that is closer to the supply opening is positioned at the upper side of a part of the wall surface that is farther from the supply opening.

7. The liquid discharge head according to claim 5, wherein the third direction is a vertical direction of which upper side is the one side,
wherein the second common channel member includes:
a supply opening through which the liquid is supplied to the second supply channel; and
a discharge opening through which the liquid is discharged from the second return channel,
wherein the discharge opening is provided in a wall surface at the upper side of the second return channel, and
wherein the wall surface at the upper side of the second return channel is inclined to the second direction so that a part of the wall surface that is closer to the discharge opening is positioned at the upper side of a part of the wall surface that is farther from the discharge opening.

8. The liquid discharge head according to claim 1, wherein the chiller includes a heat sink provided in the second common channel member.

9. The liquid discharge head according to claim 1, wherein the chiller includes a hole that is different from the second common channel and is opened in a surface at the other side in the third direction of the second common channel member.

10. The liquid discharge head according to claim 9, wherein the chiller includes a heat sink disposed in the hole.

11. The liquid discharge head according to claim 9, wherein the hole is a through hole that passes through the second common channel member in the third direction, that is disposed at an end at the one side in the third direction of the second common channel member, and that communicates with air.

12. The liquid discharge head according to claim 1, further comprising a third common channel member disposed between the actuator member and the second common channel member in the third direction,
wherein the third common channel member includes:
a plurality of third common channels corresponding to the first common channels and arranged in the second direction, each of the third common channels extending in the first direction and communicating with a corresponding one of the first common channels and the second common channel; and
an IC accommodating portion configured to accommodate the driver IC,
wherein the second common channel member has higher thermal conductivity than the third common channel member.

13. The liquid discharge head according to claim 12, wherein the second common channel member adheres to the third common channel member by adhesive having higher thermal conductivity than the third common channel member.

14. The liquid discharge head according to claim 12, further comprising a thermal conductive member disposed in the IC accommodating portion and interposed between the third common channel member and the driver IC.

15. The liquid discharge head according to claim 1, further comprising a third common channel member disposed between the actuator member and the second common channel member in the third direction,
wherein the third common channel member includes:
a plurality of third common channels corresponding to the first common channels and arranged in the second direction, each of the third common channels extending in the first direction and communicating with a corresponding one of the first common channels and the second common channel: and
an IC accommodating portion configured to accommodate the driver IC,
wherein the third common channels are formed at a part of the third common channel member that is inside the IC accommodating portion in the first direction.
